(19) United States
(12) Patent Application Publication
(10) Pub. No.: US 2013/0093978 A1
(43) Pub. Date: Apr. 18, 2013

(54) BACKLIGHT MODULE AND LIQUID CRYSTAL DISPLAY DEVICE USING THE SAME

(71) Applicants: Shih-Hsiang Chen, Shenzhen (CN); Yu-Bo Gu, Shenzhen (CN); Dan Xiao, Shenzhen (CN); Liu-Yang Yang, Shenzhen (CN)

(72) Inventors: Shih-Hsiang Chen, Shenzhen (CN); Yu-Bo Gu, Shenzhen (CN); Dan Xiao, Shenzhen (CN); Liu-Yang Yang, Shenzhen (CN)

(21) Appl. No.: 13/377,986

(22) PCT Filed: Nov. 1, 2011
(86) PCT No.: PCT/CN2011/081606

§ 371 Date: Dec. 13, 2011

(30) Foreign Application Priority Data
Oct. 14, 2011 (CN) 201110315067.0

(51) Int. Cl. G02F 1/1335; F21V 7/04

(52) U.S. Cl. 349/61; 362/606

(57) ABSTRACT

A backlight module and a liquid crystal display device using the same are provided, the backlight module comprises a light guide plate and at least one light emitting source disposed by a side of the light guide plate, and the light emitting source is disposed by a side of a corner of the light guide plate. The backlight module further comprises at least one reflecting plate disposed by an outer side of the light guide plate. Each of the reflecting plates corresponds to one of the light emitting sources, and is inclinedly disposed by the side of the light guide plate as well as by an outer side of the light emitting source. The present invention can effectively solve a problem of unevenly distributed brightness, and can tackle an obstacle for manufacturing larger sized liquid crystal display devices.

### FIELD OF THE INVENTION

The present invention relates to a liquid crystal display device and more particularly to a backlight module structure and a liquid crystal display device using the same.

### BACKGROUND OF THE INVENTION

A liquid crystal display device employs liquid crystals to display images. Typically, it is composed of a liquid crystal panel, a backlight module, related digital circuits and a power supply. Backlight module can be divided into three types in terms of a position of a light tube: 1) Edge type structure which a light source is disposed by a lateral side of a light guide plate; 2) Direct type structure which light is emitted from a spontaneous light source and is reflected by a reflecting plate to travel upward, and then is emitted from a front after it is diffused evenly by a diffusing plate; 3) Hollow type structure which a hot-cathode tube is used as a light source, and this structure uses air as a media for light. In addition, a light source pointed downward and after the light direction is adjusted and reflected by a prism and a reflecting plate, a part of the light travels upward to go through a light guide plate and is emitted from its surface, another part of the light enters into a cavity again because of total reflection, then is emitted through the light guide plate after being refracted and reflected. A light source pointed upward enters into the light guide plate and is emitted directly, or is emitted after refractions and reflections, and the light guide plate is a wedge structure.

A conventional edge type backlight module employs LED as a light emitting source. Referring to FIG. 1, since LEDs 1a have excellent directionality, thus their emitted light beam is overly concentrated, and result in pictures with unevenly distributed brightness (hot spot or spotlight effect) shown on a light emitting surface of a light guide plate 2a. With this conventional structure, an area of a display area S is reduced because of the problem of unevenly distributed brightness, which is an obstacle for manufacturing larger sized liquid crystal display devices.

### SUMMARY OF THE INVENTION

In order to solve the abovementioned technical problem, the present invention provides a backlight module structure of a liquid crystal display device which can effectively solve the problem of unevenly distributed brightness, and can tackle an obstacle for manufacturing larger sized liquid crystal display devices.

Technical solutions employed by the present invention to solve the abovementioned technical problem include providing a backlight module, the backlight module comprises a light guide plate and at least one light emitting source disposed by a side of the light guide plate, and the light emitting source is disposed by a side of a corner of the light guide plate. The backlight module further comprises at least one reflecting plate disposed by an outer side of the light guide plate. Each of the reflecting plates corresponds to one of the light emitting sources, and is inclinedly disposed by the side of the light guide plate as well as by an outer side of the light emitting source.

The technical solutions employed by the present invention to solve the abovementioned problem further include providing a liquid crystal display device which comprises the abovementioned backlight module.

Comparing with conventional techniques and according to a backlight module and a liquid crystal display device using the same of the present invention, by disposing the light emitting source at the corner of the light guide plate, and by disposing the reflecting plate inclinedly by the outer side of the light emitting source correspondingly to the light guide plate, so that the problem of unevenly distributed brightness can be solved effectively, and an obstacle for manufacturing larger sized liquid crystal display devices can also be tackled.

### BRIEF DESCRIPTION OF THE DRAWINGS

FIG. 1 is an illustration of an operating principle of a conventional liquid crystal display device and its backlight module;

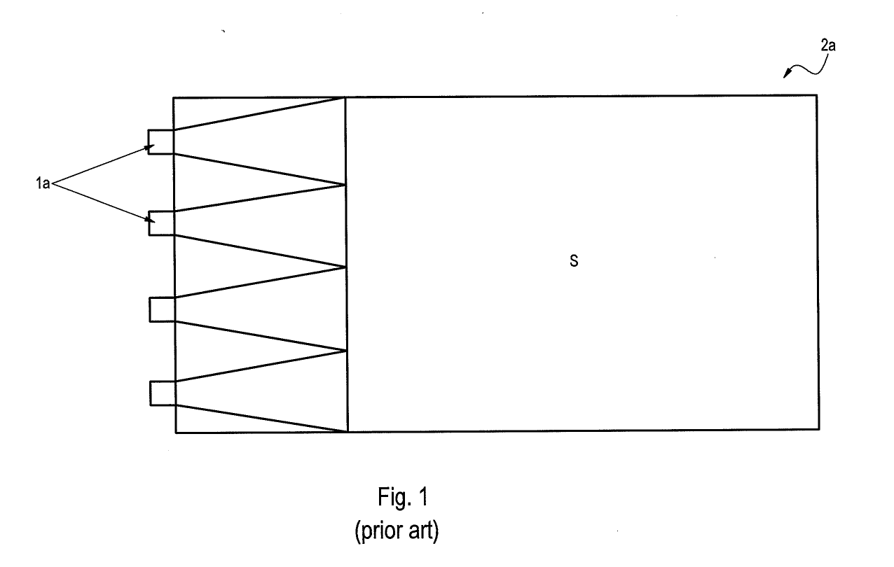

FIG. 2 is a structural illustration of a first embodiment of a liquid crystal display device and its backlight module according to the present invention; and

FIG. 3 is a structural illustration of a second embodiment of a liquid crystal display device and its backlight module according to the present invention.

### DETAILED DESCRIPTION OF THE INVENTION

The present invention will become more fully understood by reference to the following detailed description thereof when read in conjunction with the attached drawings.

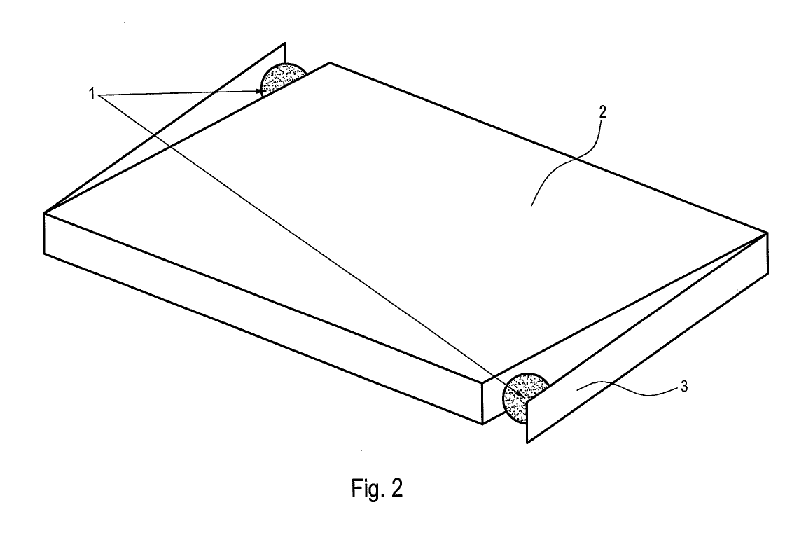

Referring to FIG. 2, a first embodiment of a liquid crystal display device and its backlight module of the present invention mainly comprises: a light emitting source 1, a light guide plate 2, and a reflecting plate 3.

The light guide plate 2 is a quadrangle shape, preferably a rectangle shape. A number of the light emitting source 1 is two in this embodiment, and are respectively disposed at two corners of the light guide plate 2 diagonally. The reflecting plate 3 corresponds to the light emitting source 1, and is inclinedly disposed by a side of the light guide plate 2 as well as by an outer side of the corresponding light emitting source 1. Each of the light emitting sources 1 faces and emits light towards the corresponding reflecting plate 3. An end of each of the reflecting plates 3 is intersected inclinedly with one of the corners of the light guide plate 2, and its another end is disposed by the outer side of the light emitting source 1. In other words, for the two corresponding corners of one of the sides of the light guide plate 2, the light emitting source 1 is disposed at one of the corners, while the reflecting plate 3 corresponding to the light emitting source 1 is intersected with the other corner of the light guide plate 2. If the reflecting plate 3 and a side of the light guide plate 2 intersected with the reflecting plate 3 are regarded as a clamp, then the light emitting source 1 is disposed at an opened end of the clamp. An included angle of the clamp is less than 90 degrees, preferably less than 45 degrees.

Preferably, the light emitting source 1 is a LED. The LED faces and emits light at an appropriate angle towards the reflecting plate 3, so that the emitted light beam can be evenly incident into the light guide plate 2 from the side via the reflecting plate 3, then transmitted evenly through a light emitting surface of the light guide plate 2, thus an evenly distributed backlight can be provided for a liquid crystal panel (not shown).

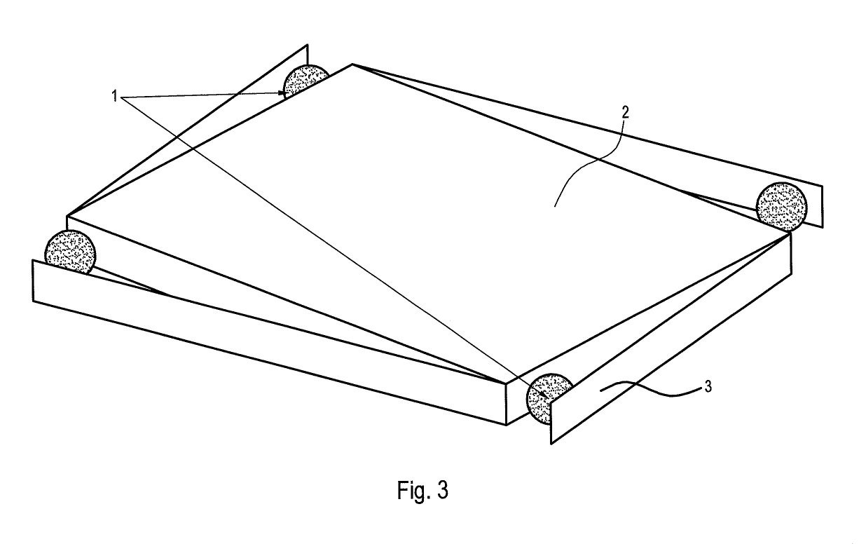

Referring to FIG. 3, differences between a second embodiment of a liquid crystal display device and its backlight module of the present invention and the abovementioned first embodiment lie in: a number of the light emitting source 1 is changed from two to four, which are disposed at the four corners of the light guide plate 2 respectively; correspondingly, a number of the reflecting plate 3 is changed from two to four, which are disposed at the four sides of the light guide plate 2 respectively.

Comparing with conventional techniques and according to a backlight module and a liquid crystal display using the same of the present invention, by disposing the light emitting source 1 at the corner of the light guide plate 2, and by disposing the reflecting plate 3 by the outer side of the light emitting source 1, the light beam emitted by the light emitting source 1 is reflected by the reflecting plate 3, so that the light beam emitted by the light emitting source 1 can be incident into the light guide plate 2 indirectly. Thereby a degree of unevenly distributed light can be reduced or eliminated, thus an effective area of a display area can be enlarged, and an obstacle for manufacturing larger sized liquid crystal display devices can also be tackled.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

1.-10. (canceled)

11. A backlight module, comprising:
a light guide plate; and
at least one light emitting source disposed by the light guide plate, and the light emitting source is disposed by a side of a corner of the light guide plate
at least one reflecting plate disposed by an outer side of the light guide plate, and each of the reflecting plates corresponds to one of the light emitting sources, and is inclinedly disposed by a side of the light guide plate as well as by an outer side of the light emitting source.

12. The backlight module as claimed in claim 11, wherein the light guide plate is a quadrangle shape, and a number of the light emitting source is two and the light emitting sources are respectively disposed at the corners of the light guide plate diagonally.

13. The backlight module as claimed in claim 11, wherein the light guide plate is a quadrangle shape, and a number of the light emitting source is four and the light emitting sources are disposed at the four corners of the light guide plate respectively.

14. The backlight module as claimed in claim 11, wherein an end of each of the reflecting plates is intersected inclinedly with one of the corners of the light guide plate, its another end is disposed by the outer side of the light emitting source.

15. The backlight module as claimed in claim 14, wherein an included angle between the reflecting plate and the light guide plate is smaller than 90 degrees.

16. The backlight module as claimed in claim 15, wherein an included angle between the reflecting plate and the light guide plate is smaller than 45 degrees.

17. The backlight module as claimed in claim 14, wherein a length and a width of the reflecting plate are the same as a length and a width of a corresponding side surface of the light guide plate.

18. The backlight module as claimed in claim 11, wherein the light emitting source is a LED.

19. The backlight module as claimed in claim 11, wherein the light emitting source faces and emits light towards the corresponding reflecting plate.

20. A liquid crystal display device, comprising the backlight module as claimed in claim 11.

21. The liquid crystal display device as claimed in claim 20, wherein the light guide plate is a quadrangle shape, and a number of the light emitting source is two and the light emitting sources are respectively disposed at the corners of the light guide plate diagonally.

22. The liquid crystal display device as claimed in claim 20, wherein the light guide plate is a quadrangle shape, and a number of the light emitting source is four and the light emitting sources are disposed at the four corners of the light guide plate respectively.

23. The liquid crystal display device as claimed in claim 20, wherein an end of each of the reflecting plates is intersected inclinedly with one of the corners of the light guide plate, its another end is disposed by the outer side of the light emitting source.

24. The liquid crystal display device as claimed in claim 23, wherein an included angle between the reflecting plate and the light guide plate is smaller than 90 degrees.

25. The liquid crystal display device as claimed in claim 24, wherein an included angle between the reflecting plate and the light guide plate is smaller than 45 degrees.

26. The liquid crystal display device as claimed in claim 23, wherein a length and a width of the reflecting plate are the same as a length and a width of a corresponding side surface of the light guide plate.

27. The liquid crystal display device as claimed in claim 20, wherein the light emitting source is a LED.

28. The liquid crystal display device as claimed in claim 20, wherein the light emitting source faces and emits light towards the corresponding reflecting plate.
